(19) United States
(12) Patent Application Publication
(10) Pub. No.: US 2024/0360876 A1
(43) Pub. Date: Oct. 31, 2024

(54) COUNTERTRACK JOINT AND AXLE SHAFT

(71) Applicant: GKN Driveline International GmbH, Lohmar (DE)

(72) Inventors: Stephan Maucher, Siegburg (DE); Thomas Weckerling, Sankt Augustin (DE); Ida Benner, Troisdorf (DE); Rolf Cremerius, St. Augustin (DE); Anna Gremmelmaier, Sankt Augustin (DE); Hans-Jürgen Post, Bonn (DE)

(21) Appl. No.: 18/291,726

(22) PCT Filed: Jul. 30, 2021
(86) PCT No.: PCT/EP2021/071507

§ 371 Date: Jan. 24, 2024

(51) Int. Cl. F16D 3/223

(52) U.S. Cl. CPC F16D 3/223; F16D 2003/22303

(57) ABSTRACT

A counter track joint comprises an outer joint part and an inner joint part, wherein first pairs of tracks widen towards the opening side of the outer joint part when the counter track joint is aligned, and second pairs of tracks widen towards the connecting side of the outer joint part when the counter track joint is aligned; a ball in each first and second pair of tracks respectively; a ball cage with circumferentially distributed cage windows, each of which accommodates one of the balls, the ball cage having a non-circular shape with at least three maxima and three minima when viewed in cross-section.

### CROSS-REFERENCE TO RELATED APPLICATION

This application is a national stage of, and claims priority to, Patent Cooperation Treaty Application No. PCT/EP2021/071507, filed on Jul. 30, 2021, which application is hereby incorporated herein by reference in its entirety.

### BACKGROUND

From DE 100 60 120 A1, a counter track joint with an outer joint part, an inner joint part, torque-transmitting balls which are accommodated in track pairs each consisting of an outer track and an inner track, and a ball cage with cage windows in which the balls are held. First outer tracks and first inner tracks form first track pairs, the first control angles of which open in a first axial direction and in which first balls are held. Second outer tracks and second inner tracks form second pairs of tracks, the second control angles of which open in a second axial direction and in which second balls are held. The outer joint part and the inner joint part are axially displaceable relative to one another. From WO 2013/029655 A1, a further counter track joint is known.

From DE 102 09 933 A1, a counter track joint is known comprising an inner race with first and second inner race tracks, an outer race with first and second outer race tracks, an annular cage which is arranged between the inner race and the outer race and has radial windows in which balls engaging the race tracks are guided. The outer race of the counter track joint is a one-piece closed ring into which the outer race tracks are formed without cutting.

A ball cage for a constant velocity plunging joint is known from EP 2 180 202 A1. The ball cage comprises circumferentially distributed windows for accommodating balls, an outer spherical control face and an outer conical free face, which is mechanically unmachined starting from a preformed blank.

From FR 1 287 546, a constant velocity plunging joint is known with an outer joint part, an inner joint part that moves longitudinally with respect to the outer part, a cage and four torque-transmitting balls that are held in cage windows. The outer joint part has a cylindrical inner face with four outer tracks extending angularly to the axis. The inner joint part has a double-conical outer face with four inner tracks running symmetrically to the outer tracks. The cage has a double-conical outer face in longitudinal section and a cylindrical inner face in cross-section with four longitudinally extending recesses into which the web areas of the inner joint part located between the inner tracks extend during the plunging movement.

A constant velocity joint with an outer joint part, an inner joint part, torque-transmitting balls and a cage is known from U.S. Pat. No. 6,224,490 B1. The outer joint part has a spherical inner face with running grooves. The inner joint part has a spherical outer face with running grooves, the number of which is equal to the number of running grooves in the outer joint part. The running grooves in the outer joint part and a run-in chamfer at the outer joint part are produced by a forming working process.

### SUMMARY

The disclosure relates to a constant velocity joint in the form of a counter-track joint and a side shaft with such a counter-track joint. The constant velocity joint in the form of a countertrack joint can be manufactured simply and efficiently and has low noise emissions. Further disclosed is a side shaft with such a counter-track joint that is efficient and low-noise.

According to the disclosure, a constant velocity joint is in the form of a counter-track joint, comprising: an outer joint part having a longitudinal axis, a connecting side and an opening side, an inner face which is at least partially curved in the longitudinal direction, and first outer ball tracks and second outer ball tracks which are arranged circumferentially distributed; an inner joint part having a longitudinal axis and first inner ball tracks and second inner ball tracks which are arranged circumferentially distributed in an outer face of the inner joint part; wherein the first outer ball tracks and the first inner ball tracks form first pairs of tracks with each other, which widen towards the opening side of the outer joint part, and wherein the second outer ball tracks and the second inner ball tracks form second pairs of tracks with each other, which widen towards the connecting side of the outer joint part, a torque-transmitting ball in each first pair of tracks and in each second pair of tracks, a ball cage which is arranged between the outer joint part and the inner joint part and which has a cage inner face, a cage outer face and circumferentially distributed cage windows which each receive at least one of the torque-transmitting balls, wherein the ball cage has an opening-side annular web and a connection-side annular web laterally adjacent to the circumferentially distributed cage windows, wherein the balls are held by the ball cage in a radial plane with coaxially aligned longitudinal axes of the inner joint part and the outer joint part; wherein, with the longitudinal axes of the outer and inner joint parts aligned with one another, an outer radial gap is formed between the outer face of the cage and the inner face of the outer joint part, and an inner radial gap is formed between the inner face of the cage and the outer face of the inner joint part; wherein the inner joint part is axially movable to a limited extent relative to the outer joint part, wherein the opening-side annular web of the ball cage can be axially supported against an opening-side supporting face of the outer joint part and/or inner joint part, and the connection-side annular web can be axially supported against a connection-side supporting face of the outer joint part and/or inner joint part; wherein at least one of the cage outer face and the cage inner face of the ball cage is softly finished and hardened; and wherein the ball cage has a non-circular shape when viewed in cross-section, with a polygonal circumferential contour of the connection-side annular web and a polygonal circumferential contour of the opening-side annular web, which each have at least three maxima and three minima and a maximum peak-to-valley value of at least 30 micrometers.

Advantageously, with the present counter track joint, that due to its non-circular shape, the ball cage only comes into contact with the outer and/or inner joint part at the axial stop at certain points and has a certain spring function. This leads to a low noise development at the stop and, due to the point contact over the circumference, to low frictional forces compared to a flat contact. Another advantage is that the ball cage can be manufactured easily and cost-effectively due to the surfaces being finish-worked before hardening. Overall, this results in a counter track joint that is easy and efficient to manufacture and has low noise emissions, particularly in the event of load changes.

The polygonal circumferential contour of the ball cage can be formed on the outer face and/or on the inner face. In the context of the present disclosure, the feature polygonal circumferential contour comprises a circumferential line which results from a cross-section or conical section through the ball cage and which has a variable radius over the circumference in relation to a circumferential line center point, so that an essentially wave-like course results. In this respect, the circumferential line can also be described as a wave profile. The maximum peak-to-valley value refers to the difference between the smallest radius and the largest radius of the polygonal circumferential line around the center point. The specified peak-to-valley value refers to the circumferential lines of both annular webs, in particular on the inside and outside, so that point contact with a slight spring effect and reduced noise development occurs at both axial end stops.

There are several options for calculating the geometric values of a polygonal circumferential line of the ball cage. For example, the enveloping circle and the pen circle of the undulating circumferential line can be determined and from this the radial difference can be derived. The enveloping circle is the smallest circle that completely encloses the circumferential line and/or all measuring points along the circumferential line. This is also referred to as the “minimum circumscribed circle” (MCC). The pen circle describes the largest circle that lies completely within the circumferential line and/or all measuring points along the circumferential line. This is also referred to as the “maximum inscribed circle” (MIC). When using this method, the radial distance between the enveloping circle and the pen circle should be greater than 30 micrometers over the entire circumference. Alternatively or additionally, the peak-to-valley value of the polygonal circumference can also be determined using the minimum circle method, which is also referred to as the “minimum zone circle” (MZC). Here, two circles with the same center point are calculated so that one is as small as possible outside and the other as large as possible inside the circumferential line and/or all measuring points of the circumferential line. When using this method, the radial distance between the two coaxial circles should be greater than 30 micrometers over the entire circumference. Alternatively or additionally, the peak-to-valley value of the polygonal circumference can also be determined on the basis of the Gauss circle, which is also known as the “least square circle” (LSC). The Gauss circle is determined in such a way that it is as close as possible to the polygonal circumference line and/or all measuring points of the circumference line. When using this method, the radial distance between the absolute maxima and absolute minima of the polygonal circumferential lines respectively the circumferential line measuring points, and the Gaussian reference circle should be greater than 15 micrometers in each case. It is understood that any of the above methods can be used to calculate the peak-to-valley value according to the disclosure. The number of measuring points used to determine the circumferential line is at least six, eight, ten or more in the area of the cage windows, depending on their number. In the area of the annular webs, the number of measuring points can also be significantly higher, for example at least 16, or be a continuous measuring line.

The ball cage has a polygonal circumferential contour on both annular webs. The polygonal inner and/or outer circumferential contour can comprise at least six maxima and six minima, for example at least eight.

In the area of an annular web, a polygonal inner circumferential contour can be at least 10 micrometers larger than a polygonal outer circumferential contour. For example, the polygonal inner circumferential contour can have a maximum peak-to-valley value of at least 30 micrometers and the polygonal outer circumferential contour can have a maximum peak-to-valley value of at least 50 micrometers. A larger peak-to-valley value and/or amplitude results in a smaller point contact in the contact with the outer joint part and/or inner joint part and a greater spring effect of the cage. For example, the maximum peak-to-valley value of the polygonal inner and/or outer circumferential contour is less than 200 micrometers, or less than 150 micrometers. The ball cage can also have both a polygonal inner and a polygonal outer circumferential face. The wave profiles of the outer and inner polygons can be in phase or out of phase in the circumferential direction.

The ball cage can have a variable wall thickness over the circumference in a circumferential section through an annular web, wherein the difference in thickness between a minimum radial thickness and a maximum radial thickness of the annular web is for example at least 50 micrometers.

According to an embodiment, the outer face, the inner face and optionally at least one end face of the ball cage can be soft finished and hardened. In the context of the present disclosure, soft finished means that the desired component geometry is produced exclusively by soft working, i.e., is produced and completed before hardening. After hardening, no further geometry-changing processing of at least a partial number of the outer faces of the ball cage is provided, including no machining. The outer face, inner face and/or end faces of the ball cage can be finished by forming, for example by forging, hot forming, cold forming, stamping and/or hammering. Alternatively or additionally, partial faces of the ball cage can be machined, at least in intermediate steps, for example by milling, turning and/or grinding operations.

Axially opposite side faces of the cage windows can be hard-machined after hardening. In the context of the present disclosure, hardened and hard-machined means that the respective workpiece face is prefabricated with appropriate oversize before hardening and is finish-machined to the desired final geometry after hardening. Prefabrication can be carried out by cutting manufacturing processes, such as turning or milling, and/or by non-cutting manufacturing processes, such as forming, forging or stamping. Finishing can be carried out by machining, for example by grinding or milling. In the course of the finishing process, the material allowance of the respective surfaces on the intermediate product, which can be a few tenths of a millimeter, for example, is removed after hardening.

In principle, the opposing faces of the outer joint part, cage and inner joint part can be freely selected according to the requirements. For example, one, several or all of the inner face of the outer joint part, the outer face of the cage, the inner face of the cage and the outer face of the inner joint part can be spherical. Alternatively or additionally, the aforementioned faces can also have cylindrical, toroidal and/or conical portions. When using a ball cage with a spherical outer face and inner face, these spherical faces can be arranged coaxially to each other, i.e., the two face center points coincide. According to an alternative possibility, the spherical faces can also be axially offset from each other, i.e., the two face center points of the inner and outer spherical cage faces have an axial distance (offset) from each other. The same applies analogously when using a spherical inner face of the outer part and/or a spherical outer face of the inner part.

With the ball cage centered relative to the outer joint part and the inner joint part, at least one of the outer radial gap and the inner radial gap can be larger than 75 micrometers according to an embodiment. The inner and outer radial gaps can be of different sizes and can deviate from each other by at least 25 micrometers. Similarly, an outer total axial clearance formed between the outer face of the cage and the inner face of the outer joint part and an inner total axial clearance formed between the inner face of the cage and the outer face of the inner joint part can also differ in size. For example, the outer total axial play may be greater than the inner total axial play by at least 10% and/or at least 100 micrometers, including at least 20% and/or at least 200 micrometers. The joint parts can also be designed in such a way that when the inner joint part is positioned axially centered in relation to the ball cage in the torque-loaded state, the outer total axial play is divided asymmetrically into an outer opening-side axial play and an outer connecting-side axial play. The axial play on the connecting side is for example smaller than the axial play on the opening side. This is advantageous in that the inner joint part can be supported axially via the ball cage against the support face of the outer joint part when a shaft is pressed in, without the balls jamming in the ball tracks or coming into press contact with the ball tracks. The different configurations of the radial and axial clearances contribute to simple and cost-effective production, as a coarse clearance is possible in one of four face pairings.

The outer and inner ball tracks can be curved, in longitudinal section through the track base respectively, at least in a central section. The first and second outer ball tracks can form an outer ball track group, and the first and second inner ball tracks can form a second ball track group, wherein, according to an embodiment, one of the outer and inner ball track groups is hardened and hard-machined, and the other of the outer and inner ball track groups is finish-worked before hardening, i.e. is mechanically unmachined after hardening and/or is not subjected to any further geometry-changing machining. The latter ball track group can, for example, be finished by chipless forming before hardening. After hardening, blasting can be carried out to improve the surface. A ball track group that is finish-worked before hardening contributes to cost-effective production. At the same time, due to (a) the hardened and then hard finished ball track group, (b) the support face of the outer joint part and (c) the counter track shape, a good guiding and support function for the ball cage and thus high efficiency is provided. If the outer ball track group is soft finished, the outer radial gap respectively the outer total axial play can be greater than the inner radial gap respectively the inner total axial play. If the inner ball track group is soft finished, the outer radial gap respectively outer total axial play is for example smaller than the inner radial gap respectively inner total axial play.

The ball tracks that are hard-machined, for example by grinding or turning, can have a lower surface roughness than the soft-finished ball tracks, i.e., the ball tracks that are unmachined after hardening. The latter can optionally have a microstructure that is created by shot peening before hardening.

The first outer ball tracks and the second outer ball tracks are for example designed such that, when viewed in cross-section, a two-point contact is formed respectively with the associated torque-transmitting ball. Alternatively or additionally, the first inner ball tracks and the second inner ball tracks can also be designed such that, viewed in cross-section, a two-point contact is formed respectively with the associated torque-transmitting ball. A two-point contact can be achieved, for example, by a gothic or elliptical track shape when viewed in cross-section. The two-point contact or two-point track makes it possible to perform a self-centering measurement of the ball tracks. In principle, however, a circular track can also be used.

Different embodiments can result from the allocation of the ball tracks finished before or after hardening to the outer or inner joint part. According to a first embodiment, the ball tracks that are soft finished before hardening can be assigned to the outer joint part, while the hardened and subsequently hard finished ball tracks are assigned to the inner joint part. According to a reverse alternative embodiment, the ball tracks that are soft-finished before hardening can be assigned to the inner joint part, while the hardened and subsequently hard-finished ball tracks are assigned to the outer joint part.

In an embodiment, the inner face of the outer part can be hardened and mechanically unprocessed after hardening. This means that the geometry of the inner face is finished or completed before hardening. After hardening, no further geometry-changing working of the inner face is provided by no machining (i.e., without machining). The inner face of the outer part can be finished by forming, for example by forging, hot forming, stamping and/or hammering. Alternatively or in addition, the inner face of the outer part can be machined, at least in intermediate steps, for example by milling, turning and/or grinding operations.

The outer face of the inner joint part can be hardened and hard-machined after hardening. This means that the outer face of the inner part is prefabricated with appropriate allowance before hardening and is finished to the desired final geometry after hardening. Prefabrication can be carried out using machining production processes, such as turning or milling, and/or non-cutting production processes, such as forming or forging. Tthe outer face can be finished by machining, for example by grinding or turning.

The first outer ball tracks can form a first undercut on the opening side, and the second outer ball tracks can form a second undercut on the opening side. The first undercut of the first ball tracks opening towards the opening side is smaller than the second undercut of the second ball tracks opening towards the connection side.

The above-mentioned implementations relate to the embodiment in which the geometry of the ball tracks of the outer joint part is produced exclusively by soft machining, and the ball tracks of the inner joint part are hard machined. It is understood that in the alternative embodiment, in which the ball tracks of the outer joint part are hard-machined and the geometry of the ball tracks of the inner joint part is produced exclusively by soft machining before hardening, the features are to be implemented in reverse accordingly.

According to an embodiment, the outer joint part and the inner joint part can be designed such that the inner joint part is angularly movable relative to the outer joint part by an articulation angle (B) of greater than 20°, e.g., greater than 30°. The first balls of the first pair of tracks form a first pitch circle diameter, and the second balls of the second pair of tracks form a second pitch circle diameter. The ratio of at least one of the first and second pitch circle diameters (PCDA, PCDB) to the largest pitch circle diameter (PCDS) of an insertion opening of the inner joint part is for example less than 2.5, e.g., less than 2.1 (PCDA/PCDS<2.5 and/or PCDB/PCDS<2.5).

The number of torque-transmitting balls and correspondingly the outer and inner ball tracks can be divisible by two and may be eight, although other numbers such as six or ten are also possible.

The disclosure further includes a side shaft for transmitting torque from a transmission to a vehicle wheel, e.g., for a rear-wheel drive of a motor vehicle, comprising a constant velocity joint on the transmission side, a constant velocity joint on the wheel side, and an intermediate shaft, wherein at least one of the constant velocity joint on the transmission side and the constant velocity joint on the wheel side is a counter track joint which is designed according to one of the above-mentioned embodiments. The side shafts with a counter track joint according to the disclosure result in low noise levels in an advantageous manner, particularly during load changes.

### BRIEF SUMMARY OF THE DRAWINGS

Exemplary embodiments are explained below with reference to the drawing figures. Herein:

FIG. 1A shows a counter track joint in a first embodiment in longitudinal section through a web area;

FIG. 1B shows a counter track joint in the first embodiment in longitudinal section through a first pair of tracks;

FIG. 1C shows a counter track joint in the first embodiment in longitudinal section through a second pair of tracks;

FIG. 1D shows a counter track joint in the first embodiment in longitudinal section in simplified representation with a first pair of tracks in the lower and a second pair of tracks in the upper half of the figure;

FIG. 1E shows a counter track joint in the first embodiment in longitudinal section as shown in FIG. 1D at the stop at the opening side;

FIG. 1F shows a counter track joint in the first embodiment in longitudinal section as shown in FIG. 1D at the stop at the connection side;

FIG. 2A shows the counter track joint from FIG. 1 with inserted shaft in coaxial alignment of the inner joint part and outer joint part;

FIG. 2B shows the counter track joint from FIG. 1 with inserted shaft in angled representation in longitudinal section through a first pair of tracks;

FIG. 2C shows the counter track joint from FIG. 1 with inserted shaft in angled representation in longitudinal section through a second pair of tracks;

FIG. 2D shows the counter track joint from FIG. 1 with inserted shaft in angled view in longitudinal section through a web area;

FIG. 3A shows the ball cage of the counter track joint from FIG. 1 in longitudinal section through two opposite cage windows;

FIG. 3B shows the ball cage of the counter track joint from FIG. 1 in cross-section in the window plane;

FIG. 3C shows the ball cage of the counter track joint from FIG. 1 in three-dimensional representation with marked measuring points in the window plane;

FIG. 4 shows an exemplary, exaggerated representation of measuring points determined in the window plane according to FIG. 3C;

FIG. 5A shows the ball cage of the counter track joint from FIG. 1 in longitudinal section through two window webs with an example of a measurement plane for a circumferential measurement of an annular web;

FIG. 5B shows the ball cage of the counter track joint from FIG. 1 with an exemplary outer circumferential contour line of the outer face of an annular web in axial view, measured in the measuring plane shown in FIG. 5A;

FIG. 5C shows the ball cage of the counter track joint from FIG. 1 with an exemplary inner circumferential contour line of the inner face of an annular web in axial view, measured in the measuring plane shown in FIG. 5A;

FIG. 6 shows the outer joint part of the counter track joint from FIG. 1 with an exemplary drawn-in auxiliary sphere;

FIG. 7 shows a schematic representation of a side shaft with a counter track joint according to the disclosure as shown in FIG. 1.

### DESCRIPTION

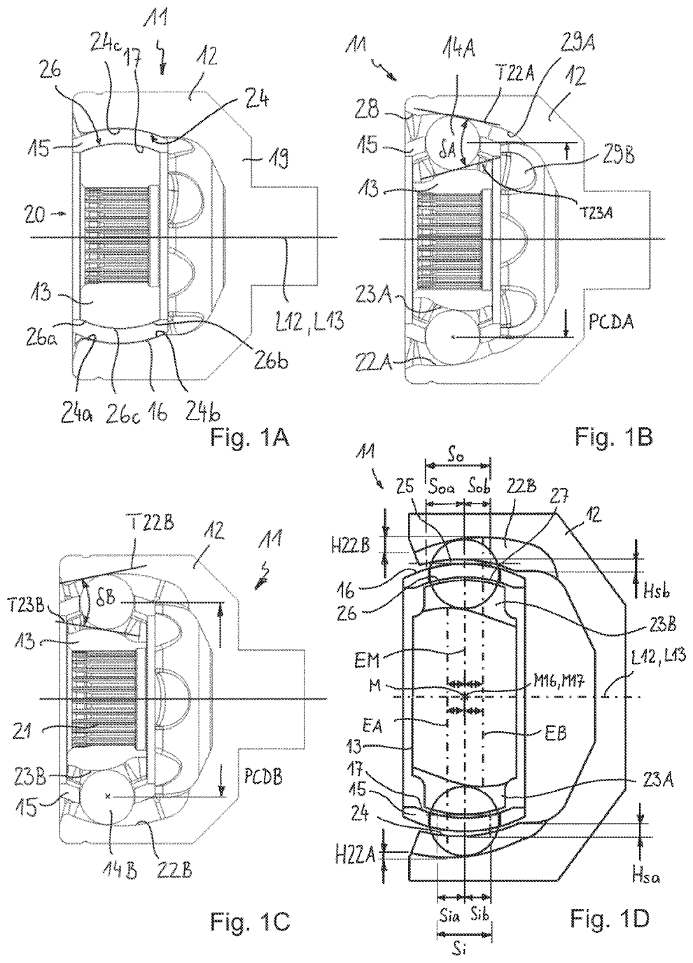

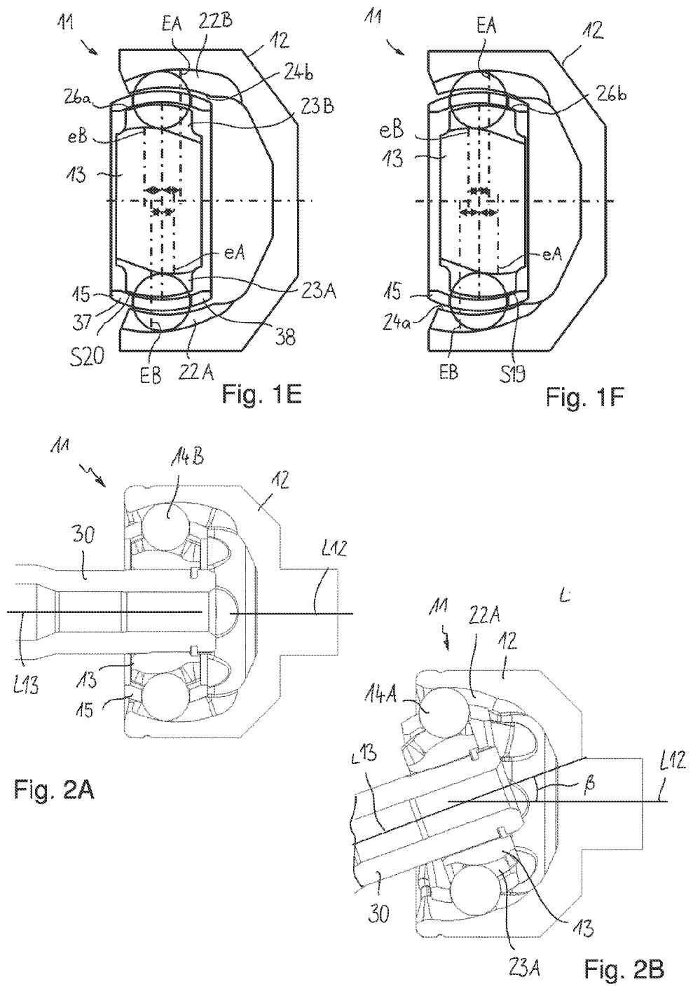

FIGS. 1A to 6, which are described together below, show a counter track joint 11. The counter track joint 11 comprises an outer joint part 12, an inner joint part 13, a plurality of torque-transmitting balls 14A, 14B and a ball cage 15. A circumferential gap 25 is formed between the substantially spherical outer face 16 of the ball cage 15 and the substantially spherical inner face 24 of the outer joint part 12. A circumferential gap 27 is also formed between the substantially spherical inner face 17 of the ball cage 15 and the substantially spherical outer face 26 of the inner joint part 13. In the present embodiment, the face centers M16 and M17 lie in a common joint center plane EM, although in a modified embodiment it is also possible for the face centers M16 and M17 to each have an axial distance (offset) in opposite directions with respect to the joint center plane EM. The balls 14A, 14B are held in circumferentially distributed cage windows 18 in the ball cage 15 in one plane. A longitudinal axis L12 is indicated on the outer joint part 12 and a longitudinal axis L13 is indicated on the inner joint part 13. The intersection of the longitudinal axes L12, L13 with the joint center plane EM, which occurs under torque load, forms the joint center point M.

In the embodiment shown here, the inner face 24 of the outer joint part 12, the cage outer face 16, the cage inner face 17 and the outer face 27 of the inner joint part 13 are substantially spherical in shape. Alternatively or additionally, one or more of the aforementioned faces may also have cylindrical, toroidal and/or conical sections. With regard to the inner face 24 of the outer part 12, an opening-side section 24a, a central section 24c and a base-side section 24b are shown in FIG. 1A. The base-side section 24b forms the support face against which the outer face 16 of the ball cage 15 can be axially supported. Furthermore, an opening-side section 26a, a central section 26c and a base-side section 26b are shown in the outer face 26 of the inner joint part 13.

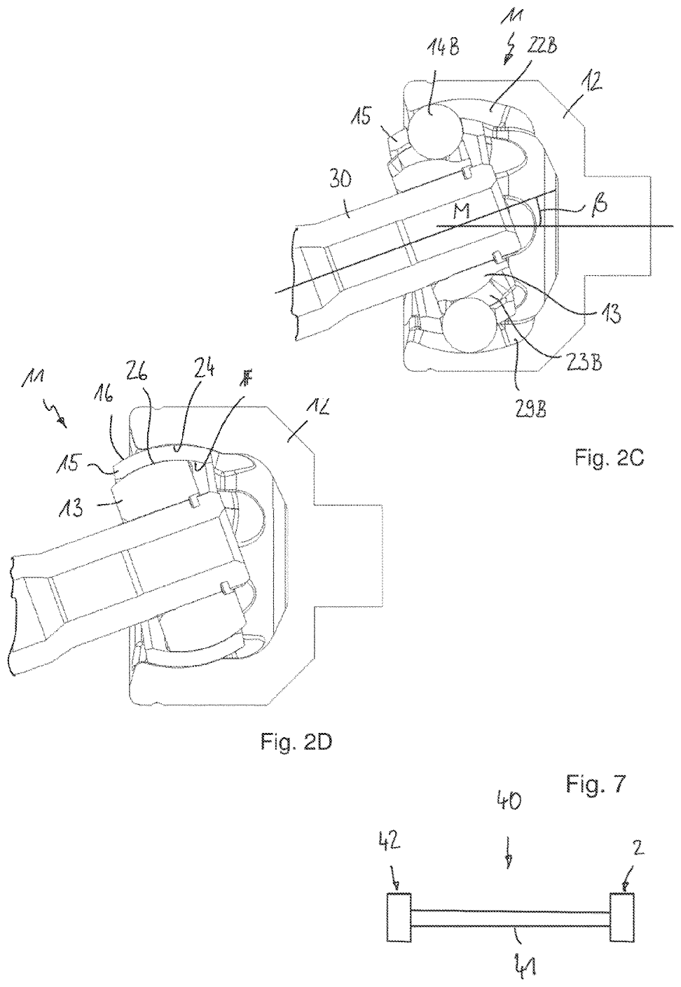

The outer joint part 12 has a base 19, which can transition into a connecting journal, for example, as well as an opening 20. The inner joint part 13 has an opening 21, into which the journal of a drive shaft 30 can be inserted in a rotationally fixed manner to transmit a torque. A counter track joint 11 with mounted shaft 30 is shown in FIGS. 2A to 2D. The position of the base 19 further denotes the axial direction “towards the connection side”, the position of the opening 20 further denotes the axial direction “towards the opening side”. These terms are also used in relation to the inner joint part, wherein the actual connection of a shaft to the inner joint part 13 is not taken into account. It is understood that instead of the base, the outer joint part can also be designed to be open towards the connection side, for example in the form of a disc joint.

First pairs of tracks 22A, 23A with torque-transmitting first balls 14A and second pairs of tracks 22B, 23B with torque-transmitting second balls 14B are provided alternately around the circumference. The shape of the first pairs of tracks 22A, 23A is shown in FIG. 1B, the shape of the second pairs of tracks 22B, 22B is shown in FIG. 1C. The first balls 14A are in contact with first outer ball tracks 22A in the outer joint part and first inner ball tracks 23A in the inner joint part. The centers of the first balls 14A define a first center line when moving along the outer and inner first ball tracks 22A, 23A, respectively, while the centers of the second balls 14B define a second center line when moving along the outer and inner second ball tracks 22B, 23B, respectively.

With the outer joint part 12 and inner joint part 13 aligned coaxially, the tangents T22A, T23A to the balls 14A form an opening angle δA at the contact points with the first tracks 22A, 23A, which opens towards the opening side. The second balls 14B are guided in outer ball tracks 22B in the outer joint part 12 and inner ball tracks 23B in the inner joint part 13. The balls 14B are shown with contact in the track base of the ball tracks, which does not necessarily have to be the case. In the aliened position shown, the tangents T22B, T23B to the second balls 14B form a second opening angle δB at the contact points with the second tracks 22B, 23B, which opens towards the connection side. In a modified track shape of the counter track joint, the opening angles orientated in opposite axial directions can also occur in a slightly angled position of the joint of up to 2°.

The first and second pairs of tracks lie with their center lines respectively in a radial plane through the joint. A respective ball 14A, 14B is accommodated in a cage window 18 in the ball cage 15. The radial planes each have the same angular distance from each other. The number of torque-transmitting balls 14A, 14B and correspondingly the number of outer and inner ball tracks is eight in the present case, without being limited thereto. Here, two first pairs of tracks 22A, 23A of the outer joint part 12 and inner joint part 13 are diametrically opposite each other, and two second pairs of tracks 22B, 23B are diametrically opposite each other.

Features of the counter track joint 11 are described in more detail below, including the design of the ball cage 15. The following definitions apply here in connection with the counter track joint according to the disclosure:

The joint articulation angle β defines the angle that is included between the longitudinal axis L12 of the outer joint part 12 and the longitudinal axis L13 of the inner joint part 13. The joint articulation angle β is zero when the joint is aligned.

The track articulation angle β/2 defines the angle that a radius from the joint center point M to the ball center encloses with the joint center plane EM. The track articulation angle β/2 is always half the joint articulation angle β in every angular position of the joint.

The opening angle δ defines the angle that is enclosed by tangents T to the balls at the contact points with the first ball tracks and/or the second ball tracks when the joint is aligned.

The control angle δ/2 defines the angle that a tangent applied to the respective ball center line at the center of the ball when the joint is aligned encloses with the associated longitudinal axis L of the outer joint part, respectively inner joint part. The control angle δ/2 corresponds to half the opening angle δ.

The center plane EM is defined by the ball centers of the torque-transmitting balls 14A, 14B when the joint is aligned.

The first pitch circle diameter PCDA defines the diameter formed by the centers of the first balls 14A when the joint is aligned.

The second pitch circle diameter PCDB defines the diameter formed by the centers of the second balls 14B when the joint is aligned.

The pitch circle diameter PCDS defines the diameter of the insertion opening of the inner joint part 13, e.g., by tooth root lines of the insertion opening.

The ball cage 15 has an opening-side annular web 37 and a connection-side annular web 38 laterally adjacent to the circumferentially distributed cage windows 18. Due to the annular gap 25, the ball cage 15 is axially movable to a limited extent relative to the outer joint part 12. This allows vibrations between the inner joint part 13 and the outer joint part that occur during operation to be compensated. Axial movement in the direction of opening 20 is limited by a stop S20 on the opening side. For this, the opening-side annular web 37 of the ball cage 15 comes into contact with the opening-side support face 26a of the inner joint part 13 and/or with the opening-side support face 24a of the outer joint part 12, as shown in FIG. 1E. Axial movement in the direction of the base is limited by a base-side stop S19. For this, the connection-side annular web 38 of the ball cage comes into contact with the connection-side support face 26b of the inner joint part 13 and/or with the opening-side support face 24b of the outer joint part 12, as shown in FIG. 1F.

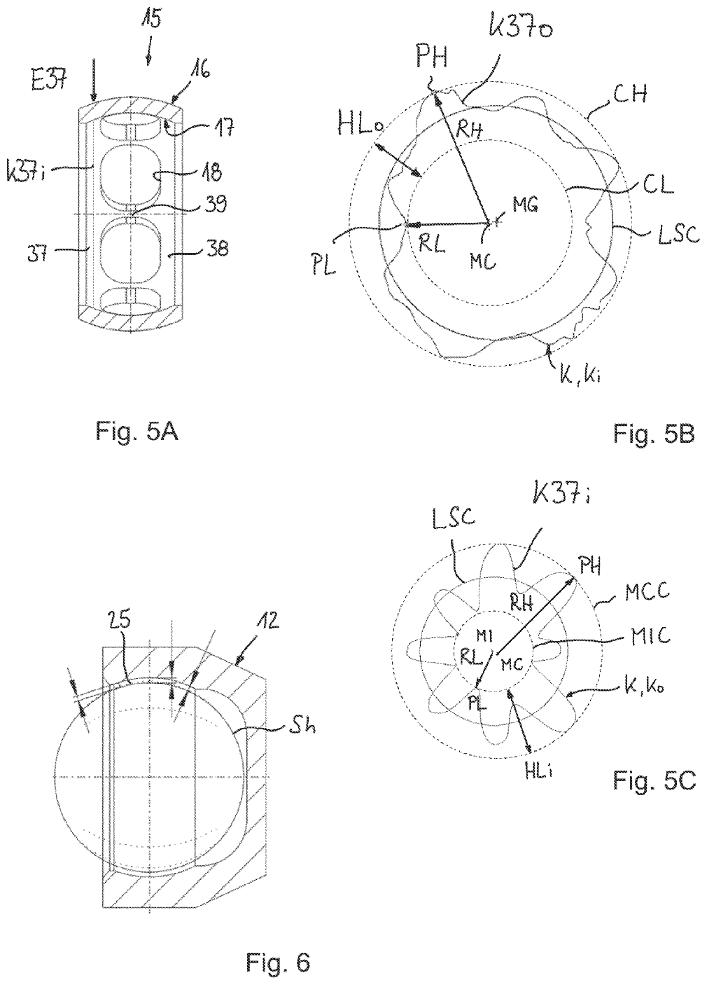

At least one of the cage outer face 16 and the cage inner face 17 of the ball cage is soft-finished and hardened. Furthermore, the ball cage 12 has a non-circular and/or polygonal shape when viewed in cross-section. As can be seen in FIGS. 4, 5B and 5C, the ball cage has polygonal circumferential contours K37, K38, K39 in the regions of the center webs 39 and annular webs 37, 38. The circumferential contours K37, K38, K39 each have at least three maxima PH, which can also be referred to as high points, and three minima PL, which can also be referred to as low points, and a maximum peak-to-valley value HL, HLo, HLi of at least 30 micrometers. The group of maxima can comprise at least one absolute maximum and several relative maxima. The group of minima can comprise at least one absolute minimum and several relative minima.

Due to the polygonal shape, the ball cage 15 only comes into contact with the outer joint part 12 and/or inner joint part 13 at the axial stop S19, S20 at least initially at several points, namely in the area of the maxima PH. Due to the punctual contact and the slight spring effect of the polygonal cage shape, the cyclical stop is “soft” and the noise development is correspondingly comparatively low.

The polygonal circumferential contours K37, K38, K39 of the ball cage 12 each have a variable radius R over the circumference in relation to a circumference line center point MK, MC, MG, MI, resulting in a wave-shaped curve. The maximum peak-to-valley value HL, HLo, HLi denotes the difference between the smallest radius RL and the largest radius RH of the polygonal circumferential line around a center point. The circle with the largest radius RH can also be referred to as the maximum circle line and the circle with the smallest radius as the minimum circle line. The maximum and minimum circle lines can be concentric or slightly offset from each other.

There are several options for calculating the geometric values of a polygonal circumference line, which is generally also indicated with the reference sign K, which are explained below by way of example.

For example, the peak-to-valley value HL of the polygonal circumferential line K can also be determined on the basis of the Gaussian circle LSC, which is also known as the “least square circle”. The Gaussian circle LSC is determined such that it is as close as possible to the polygonal circumferential line and/or all measuring points pm of the circumferential line K, as shown by way of example in FIG. 4. When using this method, it is provided according to the disclosure that the radial distance sh of the absolute maxima PH and the radial distance sl of the absolute minima PL of the polygonal circumferential line K, respectively of the circumferential line measuring points pm, to the Gaussian reference circle LSC, is greater than 15 micrometers in each case. This means that the peak-to-valley value HL, which represents the radial difference between the absolute minimum PL and the absolute maximum PH, is greater than 30 micrometers, e.g., greater than 50 micrometers.

Another method for determining the peak-to-valley value HL of the polygonal circumferential line K is the minimum circle method, which is also referred to as the “minimum zone circle” (MZC) and is explained below with reference to FIG. 5B. The outer circumferential line K37o of the annular web 37 of the ball cage 15 is shown, which was measured in the measuring plane E37 according to FIG. 5A. In the minimum circle method, two circles CH and CL with the same center point MC are calculated in such a way that one circle CH is as small as possible outside, and the other circle CL is as large as possible inside the circumferential line K and/or all measuring points pm of the circumferential line K. When using this method, the radial distance HL between the two coaxial circles CH, CL, which is indicated by HLo in FIG. 5B, should be greater than 30 micrometers, e.g., greater than 50 micrometers.

According to a further alternative or additional method, which is explained by way of example with reference to FIG. 5C, the enveloping circle MCC and the pen circle MIC of the undulating circumferential line K can be determined, and the radial difference HL can be derived from this. The outer circumferential line K37i of the annular web 37 of the ball cage 15 is shown, which was measured in the measuring plane E37 according to FIG. 5A. The enveloping circle MCC is the smallest circle that completely encloses the circumferential line K37i and/or all measuring points pm along the circumferential line. This circle has the center point MC and is also referred to as the “minimum circumscribed circle”. The pen circle MIC describes the largest circle that lies completely within the circumferential line K and/or all measuring points pm of the circumferential line. This circle has the center point MI and is also referred to as the “maximum inscribed circle” (MIC). The radial distance and/or the peak-to-valley value HL between the enveloping circle MCC and the pen circle MIC, which is designated HLi in FIG. 5C, is greater than 30 micrometers over the entire circumference, e.g., greater than 50 micrometers, optionally also greater than 75 micrometers.

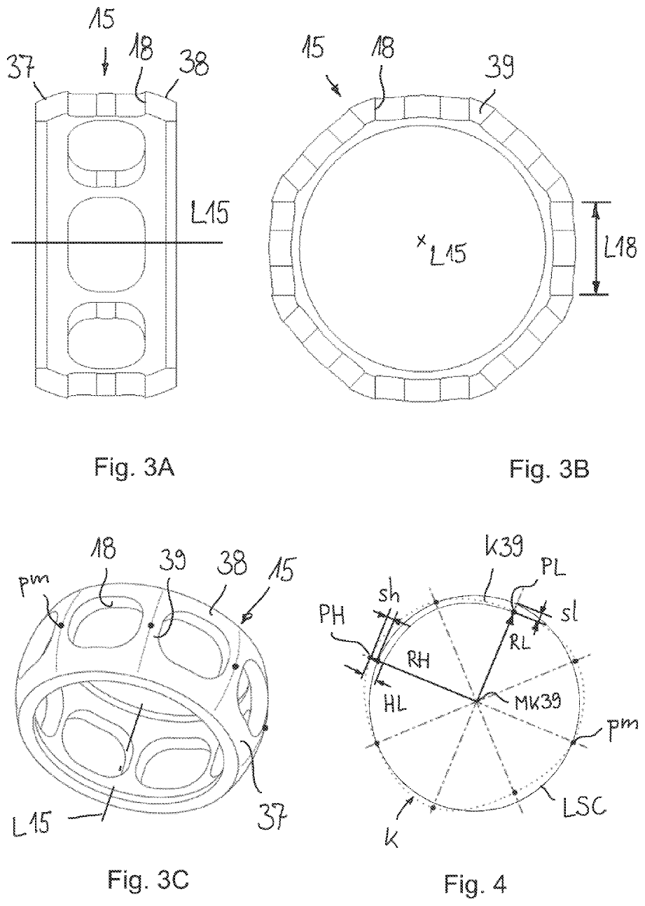

It is understood that any of the methods mentioned can be used to calculate the peak-to-valley value HL according to the disclosure. The number of measuring points used to determine the circumferential line is eight in the region of the cage windows 18, corresponding to their number, in the present example, as can be seen in FIGS. 3C and 4. In the region of the annular webs 37, 38, the number of measuring points can also be significantly higher, for example at least 16, or it can be a continuous measuring line, as shown in FIGS. 5B and 5C.

In the area of the annular webs 37, 38, a polygonal inner circumferential contour Ki can be larger, e.g., by at least 10 micrometers, than a polygonal outer circumferential contour Ko. For example, in the annular web 37, the polygonal inner circumferential contour K37i can have a maximum peak-to-valley value HL of at least 50 micrometers and the polygonal outer circumferential contour K370 can have a maximum peak-to-valley value HL of at least 30 micrometers. A larger peak-to-valley value and/or amplitude results in a smaller point contact in the contact with the outer joint part 12 and/or inner joint part 13 and a greater spring effect of the cage 15. The maximum peak-to-valley value HL of the polygonal inner and/or outer circumferential contour Ki, Ko can be less than 200 micrometers, e.g., less than 150 micrometers.

The outer face 16, the inner face 17 and optionally at least one end face of the ball cage 15 are soft finished and hardened. In other words, the desired geometry of the aforementioned faces is produced exclusively by soft machining, i.e. before hardening. After hardening, no further geometry-changing processing of at least the outer face 16 and the inner face 17 of the ball cage 15 is provided, including no machining. The outer face 16 and inner face 17 of the ball cage 15 can be finished by forming. Alternatively or additionally, partial faces of the ball cage can be machined, at least in intermediate steps.

After hardening, axially opposite side faces of the cage windows 18 can be hard-machined. This involves finishing the side faces to the desired final geometry. The windows 18 can be prefabricated using a cutting process such as punching. Finishing can be carried out including by machining, for example by grinding. During the finishing process, the allowance provided for the intermediate product on the corresponding faces, which can be a few tenths of a millimeter, for example, is removed after hardening.

The faces of the outer joint part 12, cage 15 and inner joint part 13 facing each other can in principle be freely selected according to the requirements. As can be seen in FIG. 6, in which an auxiliary sphere Sh is shown as an example, the inner face of the outer joint part is substantially spherical. The same also applies to the outer face of the cage, the inner face of the cage and the outer face of the inner joint part. When the ball cage 15 is centered in relation to the outer joint part 12 and the inner joint part 13, at least one of the outer radial gap 25 and the inner radial gap 27 is larger than 75 micrometers. The inner and outer radial gaps 25, 27 can be of different sizes and can differ from one another by at least 25 micrometers.

The cage outer face 16 of the ball cage 15 and the inner face 24 of the outer joint part 12 on the one hand, and the cage inner face 17 of the ball cage and the outer face 26 of the inner joint part 13 on the other hand, are designed such that in the assembled and aligned state of the counter track joint 11, the outer total axial play So between the ball cage 15 and the outer joint part 12 and the inner total axial play Si between the ball cage 15 and the inner joint part 13 are of different sizes. As shown in FIG. 1D, the outer total axial play So is made up of the outer opening-side axial play Soa and the connection-side axial play Sob between the cage 15 and the outer part 12. Accordingly, the inner total axial play Si is made up of the inner opening-side axial play Sia and the connection-side axial play Sib between cage 15 and inner part 13. The outer total axial play So can, for example, be at least 10% and/or at least 100 micrometers greater than the inner total axial play Si.

The spherical faces 24, 16, 17, 26 of the joint parts 12, 13, 15 are designed such that in the assembled state of the joint 11, in which the equator of the spherical face 26 of the outer joint part 12 and the equator of the cage outer face 16 lie in one plane, and the equator of the cage inner face 17 and the equator of the spherical face 26 of the inner joint part 13 lie in one plane, the outer radial gap 25 is larger in the direction of the opening side than in the direction of the connection side. In this way, the inner joint part 13 when pressing in a shaft 30 can be supported axially against the outer joint part 12 via the ball cage 15, respectively the supporting faces 26b, 24b, without the balls 14A, 14B jamming in the ball tracks 22A, 23A; 22B, 23B. In the present embodiment, the two inner and outer faces 24, 26 of the ball cage 15 are arranged substantially coaxially to one another.

The first and second outer ball tracks 22A, 22B, which together may also be referred to as outer ball tracks or outer ball track group, on the one hand, and the first and second inner ball tracks 23A, 23B, which together may also be referred to as inner ball tracks or inner ball track group, on the other hand, may be produced differently. In the present example, the ball tracks 22A, 22B of the outer joint part 12 are soft finished before hardening, and the ball tracks 23A, 23B of the inner joint part 13 are hard finished after hardening.

The outer joint part 12, including the first and second outer ball tracks 22A, 22B, can be produced by forming operations, for example by forging, hot forming, cold forming, stamping and/or hammering. It is understood that intermediate machining steps may also be provided between individual forming steps, for example for overturning and/or deburring. The first outer ball tracks 22A have an arcuate central functional section. The center of the arc generating the central functional section is offset to the opening side with respect to the center plane of the joint 11, which is also referred to as an axial offset, with an offset plane EA. At their opening-side end, the first outer ball tracks 22A of the outer joint part 12 have a radial widening 28A to facilitate the insertion of an associated ball 14A during assembly. At their base-side end, the first outer ball tracks 22A of the outer joint part 12 have a pocket 29A which is radially recessed relative to the functional track section and into which, during assembly of a ball 14Aa inserted on the opening side, the diametrically opposite ball 14Ab can plunge.

The second outer ball tracks 22B have an arc-shaped central functional section. The center of the arc creating the central functional section is offset towards the base side in the plane EB with respect to the center plane EM of the joint 11. At their base side end, the second outer ball tracks 23B of the outer joint part 12 have a pocket 29B that is radially recessed in relation to the functional track section.

The first outer ball tracks 22A form a first undercut H22A on the opening side, and the second outer ball tracks 23B form a second undercut H22B on the opening side. It can be seen in FIG. 1D that the first undercut H22A of the first ball tracks 22A opening towards the opening side is smaller than the second undercut H22B of the second ball tracks 22B opening towards the connection side.

In the present outer joint part 12, the spherical face 24 is for example also soft finished, i.e., it remains mechanically unmachined after hardening. The entire inner contour of the outer joint part 12 with ball tracks 22A, 22B and sphere 24 is therefore finished before hardening. No further geometry-changing processing is provided after hardening. The inner face 24 of the outer joint part can be produced together with the first and second outer ball tracks 22A, 22B by forming operations.

The first and second outer ball tracks 22A, 22B are shaped in such a way that a two-point contact with the associated ball 14A, 14B is formed in cross-section by the respective ball track. A two-point contact can be created, for example, by a gothic or elliptical track shape in cross-section.

The inner joint part 13, including the first and second inner ball tracks 23A, 23B, can be produced by machining processes such as turning and/or milling, although production by forming operations is also possible. The inner ball tracks 23A, 23B can be prefabricated with appropriate allowances before hardening. After hardening, the inner ball tracks 23A, 23B are finish-worked to the desired final geometry. Finish-working is carried out by machining, for example by grinding and/or turning operations. The first and second inner ball tracks 23A, 23B are for example also designed such that a two-point contact with the associated ball 14A, 14B is formed in the cross-section through the respective ball track.

In the present embodiment, the spherical outer face 26 of the inner joint part 13 is for example also initially soft pre-machined, then hardened and hard finished after hardening. The pre-machining can be carried out by machining production processes, such as turning or milling, and/or by non-cutting production processes, such as forming or forging. The outer face 26 of the inner joint part is finished, including by machining, for example by grinding.

The counter track joint 2 shown here is for example designed such that the joint parts 12, 13 can be angularly moved relative to each other by an articulation angle β of more than 20°. The ratio of the first and/or second pitch circle diameter PCDA, PCDB to the largest pitch circle diameter PCDS of the insertion opening of the inner joint part 13 can be less than 2.5, i.e. PCDA/PCDS<2.5 and/or PCDB/PCDS<2.5.

FIG. 7 shows a side shaft 40 for transmitting torque from a transmission to a vehicle wheel, which are not shown. The side shaft 40 comprises a constant velocity joint 42 on the transmission side, a shaft 41 and a constant velocity joint 2 on the wheel side. The constant velocity joint on the wheel side is a counter track joint as shown in FIGS. 1A to 1D. The side shaft 40 can be used in a rear-wheel drive of a motor vehicle.

### LIST OF REFERENCE SIGNS

11 counter track joint
12 outer joint part
13 inner joint part
14A, 14B ball
15 ball cage
16 outer face (15)
17 inner face (15)
18 windows
19 connecting side
20 opening page
21 opening
22A, 22B outer ball track
23A, 23B inner ball track
24 inner face (12)
25 outer gap
26 outer face (13)
27 inner gap
28 radial widening
29 pocket
30 shaft
31 recess
32 web (12)
33 web (13)
34 widening
35A, 35B flattening
36 opening
37,38 annular web
39 central web
40 side shaft
41 shaft
42 constant velocity joint
C circle
EA first offset plane
EB second offset plane
EM joint center plane
HL peak-to-valley value
K circumferential contour line
L longitudinal axis
M joint center
mp measuring point
PCD circle diameter
PH maximum
PL minium
R radius
S19, S20 stop
Si inner total axial play
So outer total axial play
T tangent
β articulation angle
δ opening angle

1-16. (canceled)

17. A counter track joint comprising:
an outer joint part with a longitudinal axis, sides including a connection side and an opening side, an inner face which is at least partially curved in the longitudinal direction, and first outer ball tracks and second outer ball tracks which are arranged circumferentially distributed;
an inner joint part with a longitudinal axis as well as first inner ball tracks and second inner ball tracks that are arranged circumferentially distributed in an outer face of the inner joint part;
wherein the first outer ball tracks and the first inner ball tracks respectively form first pairs of tracks, which widen towards the opening side of the outer joint part, and
wherein the second outer ball tracks and the second inner ball tracks respectively form second pairs of tracks that widen towards the connection side of the outer joint part,
a torque-transmitting ball in each first pair of tracks and in each second pair of tracks,
a ball cage arranged between the outer joint part and the inner joint part, and having a cage inner face, a cage outer face and circumferentially distributed cage windows, each of which accommodates at least one of the torque-transmitting balls, wherein the ball cage includes, laterally adjacent to the circumferentially distributed cage windows, an opening-side annular web and a connection-side annular web, wherein with coaxially aligned longitudinal axes of the inner joint part and the outer joint part, the balls are held by the ball cage in a radial plane;
wherein, with the longitudinal axis of the outer joint part and the longitudinal axis of the inner joint part aligned with one another, an outer radial gap is formed between the cage outer face and the inner face of the outer joint part, and an inner radial gap is formed between the cage inner face and the outer face of the inner joint part;
wherein the inner joint part is axially movable to a limited extent relative to the outer joint part, wherein the opening-side annular web of the ball cage can be axially supported against an opening-side supporting face of at least one of the outer joint part or inner joint part, and the connection-side annular web can be axially supported against a connection-side support face of at least one of the outer joint part or inner joint part;
wherein at least one of the cage outer face and the cage inner face is soft finished and hardened; and
wherein the ball cage, viewed in cross-section, has a non-circular shape such that, upon axial movement, the opening-side annular web coming into contact with the opening-side supporting face and the connection-side annular web coming into contact with the connection-side supporting face each have a polygonal circumferential contour with at least three maxima and three minima and a maximum peak-to-valley value of at least 30 micrometers.

18. The counter track joint according to claim 17,
wherein the maximum peak-to-valley value of the polygonal circumferential contour is less than 200 micrometers.

19. The counter track joint according to claim 17,
wherein the polygonal peripheral contour comprises an inner peripheral contour and an outer peripheral contour, and the maximum peak-to-valley value of the inner peripheral contour is greater by at least 10 micrometers than the maximum peak-to-valley value of the outer peripheral contour.

20. The counter track joint according to claim 17,
wherein the ball cage has in a cross-section through one of the annular webs a variable wall thickness over the circumference, wherein a difference in thickness between a smallest radial thickness and a largest radial thickness is at least 50 micrometers.

21. The counter track joint according to claim 17,
wherein the polygonal circumferential contour has at least six maxima and six minima.

22. The counter track joint according to claim 17,
wherein, in a centred arrangement of the ball cage relative to the outer joint part and the inner joint part, at least one of the outer radial gap and the inner radial gap is greater than 75 micrometers and the other of the outer radial gap and the inner radial gap is greater than 50 micrometers.

23. The counter track joint according to claim 17,
wherein in a load-free condition an outer total axial play, which is formed between the cage outer face and the inner face of the outer joint part, and an inner total axial play, which is formed between the cage inner face and the outer face of the inner joint part, are of different sizes, wherein the outer total axial play is at least 10% greater than the inner total axial play.

24. The counter track joint according to claim 23,
wherein, when the inner joint part is positioned axially centered to the ball cage with respect to the inner total axial play in a torque-transmitting condition, the outer total axial play is divided asymmetrically into an outer opening-side axial play and an outer connection-side axial play.

25. The counter track joint according to claim 17,
wherein the first outer ball tracks and the second outer ball tracks form an outer ball track group, and the first inner ball tracks and the second inner ball tracks form an inner ball track group,
wherein one of the outer ball track group and the inner ball track group is hardened and hard-machined, and the other of the outer ball track group and the inner ball track group is finish-worked before hardening, i.e., is mechanically unmachined after hardening.

26. The counter track joint according to claim 25,
wherein the other of the outer ball track group and the inner ball track group is finish-worked by chipless forming.

27. The counter track joint according to claim 17,
wherein the first outer ball tracks have a first outer undercut at the opening side, and the second outer ball tracks have a second outer undercut at the opening side, with the first outer undercut being smaller than the second outer undercut.

28. The counter track joint according to claim 17,
wherein the inner face, the first outer ball tracks and the second outer ball tracks of the outer joint part are soft-finished and hardened, and
the first inner ball tracks and second inner ball tracks of the inner joint part are hardened and hard-finished.

29. The counter track joint according to claim 17,
wherein the first outer ball tracks and the second outer ball tracks of the outer joint part are hardened and hard-finished after hardening, and
the first inner ball tracks and second inner ball tracks of the inner joint part are soft-finished and hardened.

30. The counter track joint according to claim 17,
wherein the first outer ball tracks and the second outer ball tracks are designed such that, viewed in cross-section, a two-point contact is respectively formed with the associated torque-transmitting ball, and
wherein the first inner ball tracks and the second inner ball tracks are designed in such a way that, viewed in cross-section, a two-point contact is respectively formed with the associated torque-transmitting ball.

31. The counter track joint according to claim 17,
wherein the outer joint part and the inner joint part are designed such that the inner joint part is angularly movable relative to the outer joint part by an articulation angle of greater than 20°.

32. The counter track joint according to claim 17, implemented in a side shaft for transmitting torque from a transmission to a vehicle wheel.
